(19) United States
(12) Patent Application Publication
(10) Pub. No.: US 2010/0272501 A1
(43) Pub. Date: Oct. 28, 2010

(54) Insertable index application kit and method of using the same

(76) Inventor: Soon Huat Lim, Gerogetown (MY)

Correspondence Address: SOON HUAT LIM;PERUSAHAAN BAYAN LEPAS, PLOT 16 KAW, PHASE 4, MK 12, GEORGETOWN, 11900, MY

(21) Appl. No.: 12/385,984

(22) Filed: Apr. 27, 2009

(51) Int. Cl. B42F 19/00

(52) U.S. Cl. 402/79

(57) ABSTRACT

An insertable index application kit consists of at least one set of divider sheets, each having insertable index tabs attached to the outer edge of the divider sheets or a set of individual insertable tabs, at least one index insert sheet perforated into at least one index insert strip which include one set of index inserts defined by perforated lines and a pre-inserted strip. The pre-inserted strip is pre-inserted into the insertable tabs; holding and binding the divider sheets or the multiple individual insertable tabs together in a set. A user may (1) separate an index insert strip from the index insert sheet, (2) attach the index insert strip to one end of the pre-inserted strip, (3) pull the pre-inserted strip away from divider sheets or individual insertable tabs such that the new index insert strip with perforated index inserts for each individual tab is fitted and aligned in the insertable tab's pocket, and (4) tear along the perforated lines such that the index inserts remain in each individual insertable tab's pocket.

### CROSS-REFERENCE TO RELATED APPLICATIONS

| | | |
|---|---|---|
| 3,938,268 | February 1976 | Gilhula |
| 4,516,871 | May 1985 | Leitman |
| 4,784,508 | November 1988 | Shannon |
| 4,422,672 | December 1983 | Levi |
| 5,503,487 | April 1996 | Ong |
| 5,540,513 | July 1996 | Wyant |
| 5,947,525 | July 1999 | Pollman |
| 6,089,777 | July 2000 | Wong |

### STATEMENT REGARDING FEDERALLY SPONSORED RESEARCH OR DEVELOPMENT

Not Applicable

### REFERENCE TO SEQUENCE LISTING A TABLE, OR A COMPUTER PROGRAM LISTING COMPACT DISC APPENDIX

Not Applicable

### BACKGROUND OF THE INVENTION

Many different types of indexing and labeling system have long been in use to help in organizing and subdividing documents into subsection so that the categories of document can be easily identified and accessed. U.S. Pat. Nos. 3,938,268, 4,516,871, 4,784,508, 4,422,672, 5,503,487, 5,540,513, 5,947,525, 6,089,777 and many others may be referred to as the examples of various indexing and labeling systems.

One of the most common and widely used indexing systems is the index divider sheets with insertable tabs for applying index inserts carrying index indices to help grouping and identifying different types of documents. One of the problems associated with index divider sheets with insertable tabs is that the job of inserting the index insert into the insertable tab's pocket has been very clumsy, difficult, tedious and time consuming. The method of inserting index inserts carrying the index indices has not been easy to use as the index inserts must be separated from one another and then inserted manually and individually into the corresponding pockets of the insertable tabs of the divider sheets. Moreover, the pockets of the insertable tabs are designed with very small and minimal opening to prevent the index inserts from falling out of the pockets. These small openings made the task of inserting the index insert into the insertable tabs' pockets even more difficult.

The present invention relates to a new design of insertable index application kit and the method of using the same for inserting the index inserts into the pocket of the insertable tabs for a given set of divider. The kit comprises insertable index divider sheets or multiple individual insertable tabs, a pre-inserted strip and an index insert strip for facilitating the inserting of index insert into the pockets of insertable tabs in a fast and effective way. With this innovative kit and method, users are able to insert all of the index inserts into the divider insertable tabs' pockets concurrently, without having to manually insert the index inserts into the insertable tabs' pockets one by one.

### BRIEF SUMMARY OF THE INVENTION

Therefore, the objective of the present invention is to offer a new design for the insertable index divider application kit and the method of using the same, wherein the user is able to slot in the index inserts into all of the insertable tabs on a given set of dividers concurrently, without having to manually and individually insert the index inserts into the insertable tabs' pockets and with the index inserts accurately attached to the insertable tabs' pocket.

Another object of this invention is also to provide a user friendly way for inserting index inserts to a set of individual insertable tabs. The insertable tabs with index inserts carrying index indices can be adhered to the outer edge of a set of document at different locations for organizing and subdividing documents into subsection so that the categories of document can be easily identified and accessed.

The insertable index application kit comprises at least one set of insertable index divider sheets or a set of individual insertable tabs, a pre-inserted strip attached to the set of divider sheets or the set of insertable tab's pockets and an index insert strip which is perforated into at least one index insert or a plurality of index inserts in the size of the insertable tabs' pockets or smaller.

The index insert strip with index inserts carrying printed index indices is attached to the pre-inserted strip at one end wherein the pre-inserted strip is pre-inserted in every pocket of the insertable tabs of a given set of divider sheets; holding and binding the divider sheets together in a set. Otherwise, the index insert strip with index inserts carrying printed index indices is attached to the pre-inserted strip at one end wherein the pre-inserted strip is pre-inserted in every pocket of the set of individual insertable tabs holding the individual insertable tabs in a series. The pre-inserted strip can be with or without index inserts defined by perforated lines or die cut lines.

By pulling out the pre-inserted strip from the insertable tabs' pockets, the index insert strip with index inserts carrying printed index indices is slotted into the insertable tabs' pockets of the divider sheets or the set of individual insertable tabs, replacing the pre-inserted strip. The index insert strip with index inserts is aligned so that the index inserts and the insertable tabs are in matching arrangement with one another. The strip is separated into individual index inserts by tearing along the perforated lines so that the index inserts remain in position with its matching tab's pocket.

### BRIEF DESCRIPTION OF THE SEVERAL VIEWS OF THE DRAWING

FIG. 1 is a top perspective view of an insertable index application kit which is made in accordance with the present invention.

FIG. 2 is a top perspective view of the divider sheets attached with insertable tabs forming a part of the application kit of FIG. 1.

FIG. 3 is a fragmentary pictorial view of a pre-inserted strip fitted in the pockets of insertable tabs forming part of the kit of FIG. 1.

FIG. 4 is a top perspective view of a pre-inserted strip of FIG. 3.

FIG. 5 is a top perspective view of an index insert sheet having multiples of index insert strips and index inserts forming part of the kit of FIG. 1.

FIG. 6 is a pictorial view of a double layer index insert strip forming part of the index insert sheet as shown in FIG. 5 being removed of its corners.

FIG. 7 is a fragmentary pictorial view of a pre-inserted strip being disposed of its release coating material from its adhesive coating material.

FIG. 8 is a pictorial view of an insert strip being pulled into the insertable tabs' pockets of the divider sheets.

FIG. 9 is a pictorial view of an index insert being separated from the insert strip and attached to its respective insertable tab.

FIG. 10 is the top perspective view of an alternative insertable index application kit.

### DETAILED DESCRIPTION OF THE INVENTION

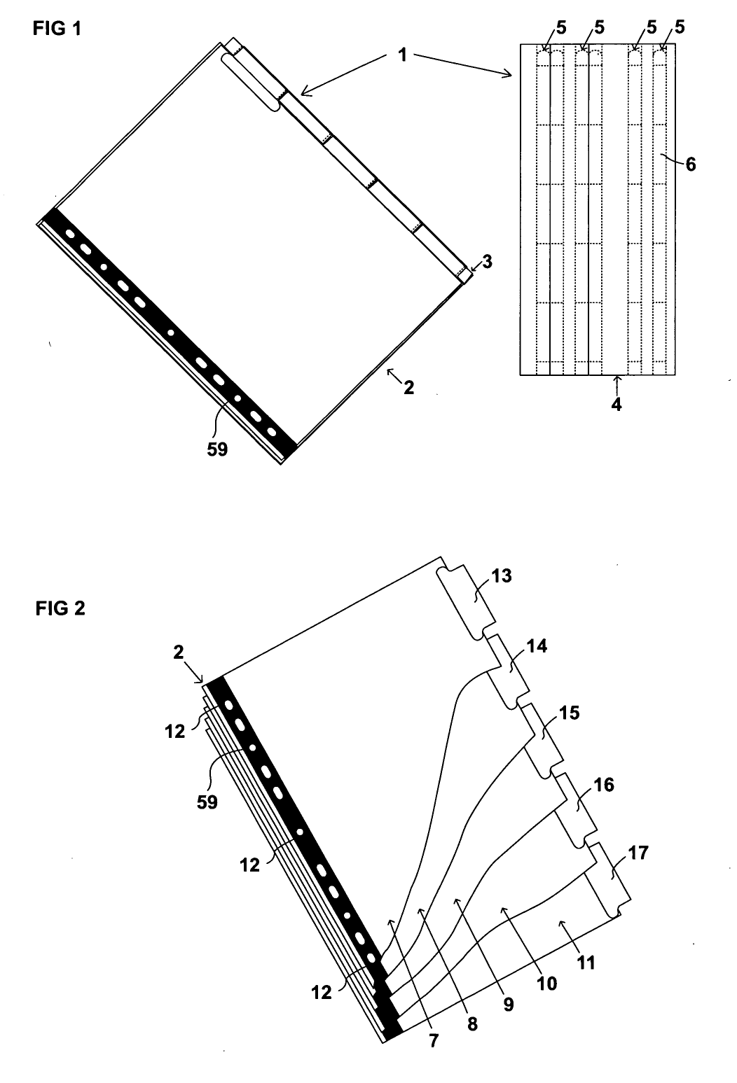

Referring to FIG. 1, it is shown an insertable index application kit 1 which is made in accordance with the present invention. The kit 1 generally consists of a set of dividers 2 for organizing and subdividing documents into subsection so that the categories of document can be easily identified and accessed, a pre-inserted strip 3 and an index insert sheet 4 having a set of index insert strips 5 in which the index insert strips 5 include a set of index inserts 6.

The set of dividers 2 consists of five individual divider sheets, such as divider sheets 7-11 (refer to FIG. 2), generally of standard 8.5 inch and 11 inch size but can be available in other sizes. The number of divider sheets consisted in a set of divider may be of any amount even though in the present embodiment, a set of five divider sheets is shown. Each of the divider sheets 7-11, are usually provided with a plurality of holes 12 at one edge for the ease of filing the divider sheets in a ring binder. The holes 12 are reinforced with reinforcing tape 59. Each of the divider sheets 7-11 has an insertable index tab 13-17 attached to the other outer edge of the divider sheets 7-11 at a different location in a predetermined order when divider sheets 7-11 are put on top of each other such that the insertable tabs 13-17 do not overlap each other when said divider sheets are put on top of each other. The insertable index tabs 13-17 are generally made of polyester film that may be clear or tinted a color as desired. However, any plastic or transparent material can be used for insertable index tabs 13-17. The insertable index tabs 13-17 are generally open at top and bottom end so that index inserts carrying the index indicia can be inserted into the tab.

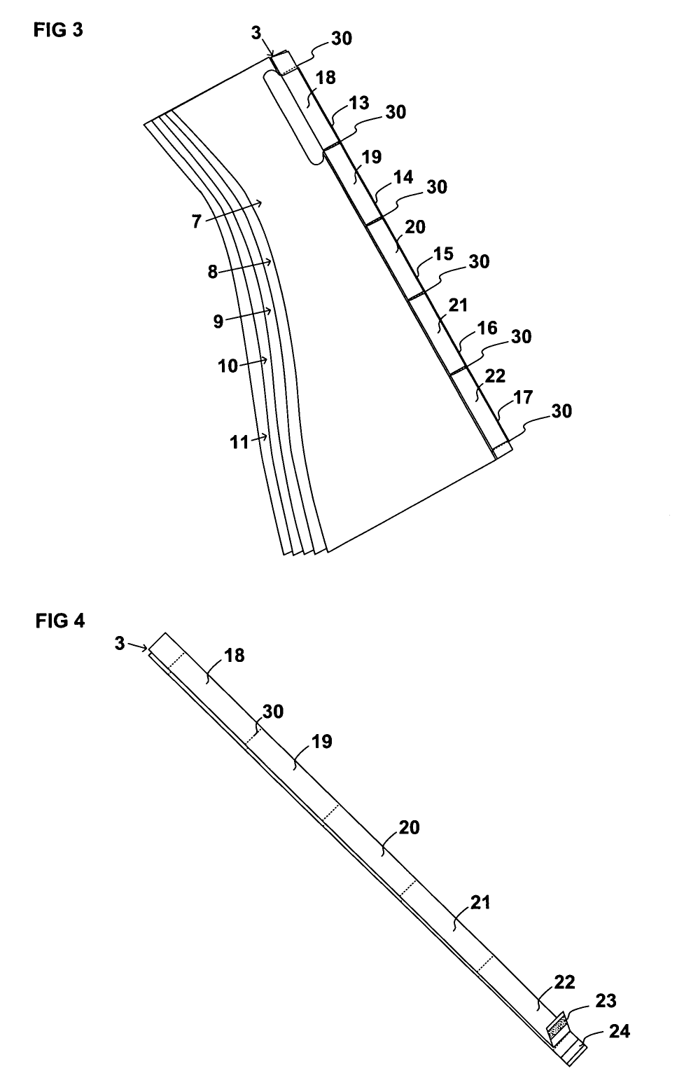

As shown in FIG. 3, the pre-inserted strip 3 having five index inserts 18-22 defined by micro-perforated lines or any perforated lines 30 is pre-inserted into all of the pockets of insertable index tabs 13-17 which are attached to the divider sheets 7-11, binding and holding the divider sheets 7-11 together in a set. Although in the present embodiment, the pre-inserted strip 3 consists of five index inserts 18-22, the pre-inserted strip 3 may consists of no index insert or any amount of index inserts. The number of index inserts is generally equivalent to the number of divider sheets in a given set of divider. The pre-inserted strip 3 may also be a single layer strip or a strip folded on itself forming a double layer strip as shown in FIG. 4. Also, the pre-inserted strip may be preprinted with desired indexing information or just a plain strip. Generally, the pre-inserted strip 3 is made of relatively stiff paper or cardboard and has a width of about ⅖ inch and a length of 11 inch. However, the pre-inserted strip 3 may be of any width, length and material as long as it can be fitted through all of the pockets of the insertable index tabs 13-17. In general, an adhesive material 23 with release coating of material 24 of ⅕ inch in length and ⅖ inch in width is adhered to one end of the pre-inserted strip 3 to facilitate the attachment of index insert strip 5 to the pre-inserted strip 3. However, any suitable material of suitable sizes and thickness can be placed at various positions of the pre-inserted strip 3 or the index insert strip 5 to help connecting the index insert strip 5 to the pre-inserted strip 3. The index insert strip 5 can also be connected to the pre-inserted strip 3 by any other form of fastening means. By way of example but not limitation, self adhesive tape with silicone coating material can be placed on top of or at the bottom of the pre-inserted strip 3 or the index insert strip 5.

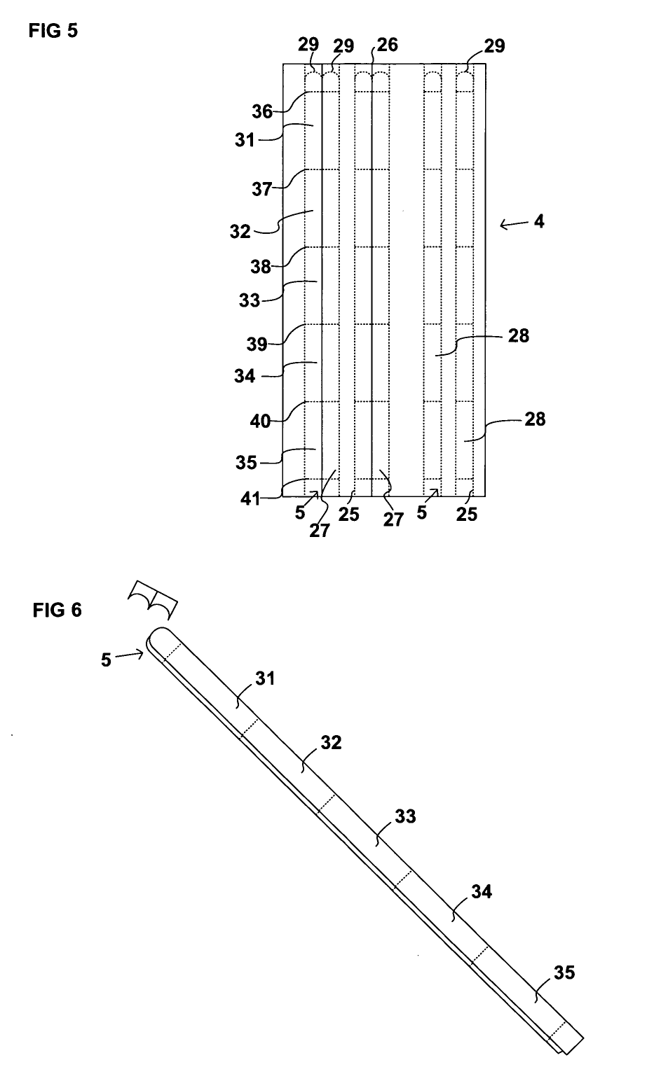

The index insert sheet 4 generally has 8.5 inch in width and 11 inch in length to facilitate printing on the index inserts 6 through a standard laser/inkjet printer or copier. The index insert sheet 4 is generally made of relatively stiff paper or cardboard. However, any suitable and printable material of various sizes may be used as index insert sheet 4. Referring to FIG. 5, the index insert sheet 4 is divided into a number of index insert strips 5 by micro perforated lines, perforated lines or die cut lines 25. The index insert strip 5 generally has a creasing line or micro perforated lines 26 to facilitate the folding of the strip on itself to form a double layer strip 27. However, the index insert strips 5 may also be a single layer strip 28. The index insert strips 5 generally have radiuses at two corners or round edges defined by micro perforated line 29 for preventing jams when pulling through the pockets of insertable tabs of the divider sheets. However, it is important to note that the edge of the index insert strips may be in any shape and size which facilitate the attachment of the index insert strips 5 to the pre-inserted strip 3.

Considering the index insert strips 5 in detail with reference to FIG. 1 and 5, each index insert strip 5 is micro perforated or die cut 36-41 into a set of five index inserts 31-35 aligned in an arrangement that corresponds to the predetermined order of insertable index tabs when said divider sheets are put on top of each other. Each of the index inserts 31-35 has a dimension about the same as the inner dimension of the pockets of insertable tabs 13-17 such that the index inserts 31-35 can be fitted in the pockets of the insertable tabs 13-17. In the case of double layer index inserts 31-35 as explain before when the index insert strip 5 is folded on itself to form a double layer strip 27, the index inserts 31-35 has a dimension after folding about the same as the inner dimension of the pockets of insertable tabs 13-17. Although the present embodiment showed that the index insert strip 5 includes five index inserts 31-35, the number of index inserts in a strip may be in any quantity. The number of index inserts in a strip is usually equivalent to the number of divider sheets in a given set of divider.

The method of using the insertable index application kit begins with the opening of the product packaging. The divider sheets 7-11 are already stacked together in a set by the pre-inserted strip 3.

The user then decides if the preprinted index inserts 18-22 on the pre-inserted strip 3 is desired or other appropriate indexing information is preferred to be printed, typed or handwritten on the index inserts 31-35 of the new index insert strip 5. If the user decides to use the existing index inserts 18-22, the micro perforated lines or perforated lines 30 are separated, leaving the index inserts 18-22 in the pockets of the insertable tabs 13-17. Otherwise, relevant indexing indices corresponding to their associated insertable tabs 13-17 are printed, typed or handwritten on the index inserts 31-35.

The index strip 5 containing the index inserts 31-35 is removed from the index insert sheet 4 by tearing along the micro-perforated lines or die cut lines 25. The index insert strip 5 is removed of its corner to form a rounded edge by tearing along micro-perforated lines or die cut lines 29 which define the strip edge. Since the strip edge may be of any shapes and sizes as explained previously, the step of removing the corners from the index insert strip 5 may not be necessary. Subsequently, if a double layer index insert strip is used, the index insert strip 5 is folded on itself along the creasing line or micro perforated line 26 to form a double layer strip as illustrated in FIG. 6.

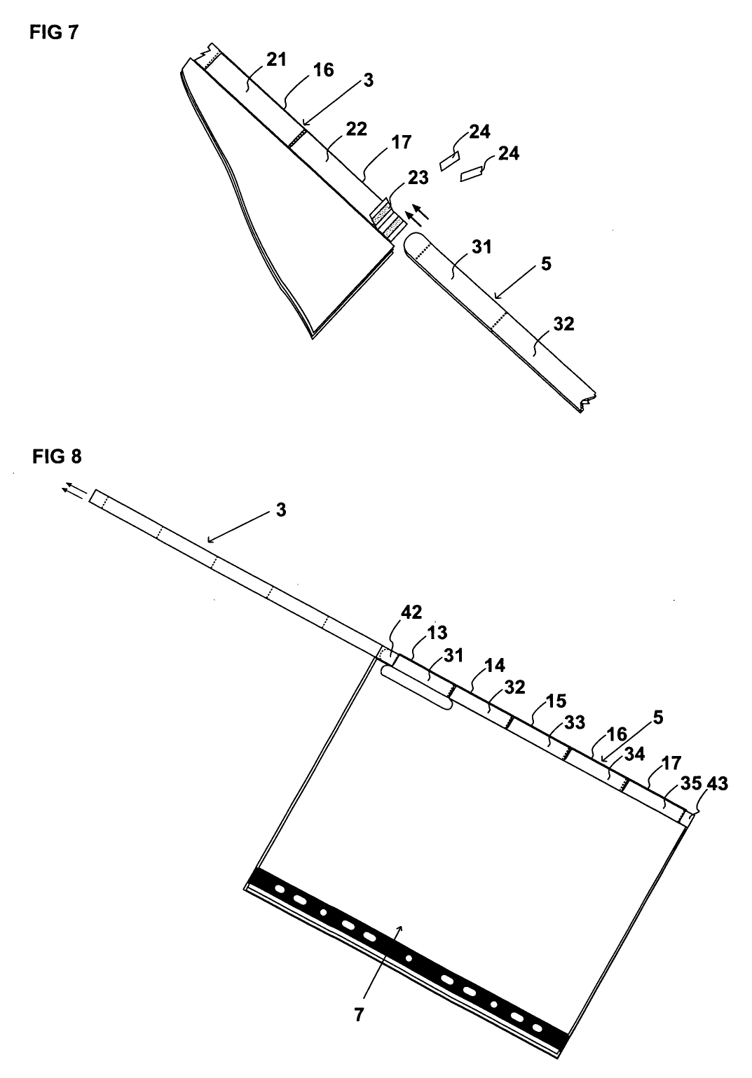

With reference to FIG. 7, the release coating of material 24 is peeled off from the adhesive coating material 23.The rounded end of the index insert strip 5 is adhered onto adhesive coating material 23 at one end of the pre-inserted strip 3.

The pre-inserted strip 3 is pulled out and away from the pockets of the insertable tabs 13-17 and divider sheets 7-11 from the other end such that the index insert strip 5 replaces the pre-inserted strip 3 in the pockets of the insertable tabs 13-17 as shown in FIG. 8. The index inserts 31-35 are aligned with their matching insertable tabs 13-17.

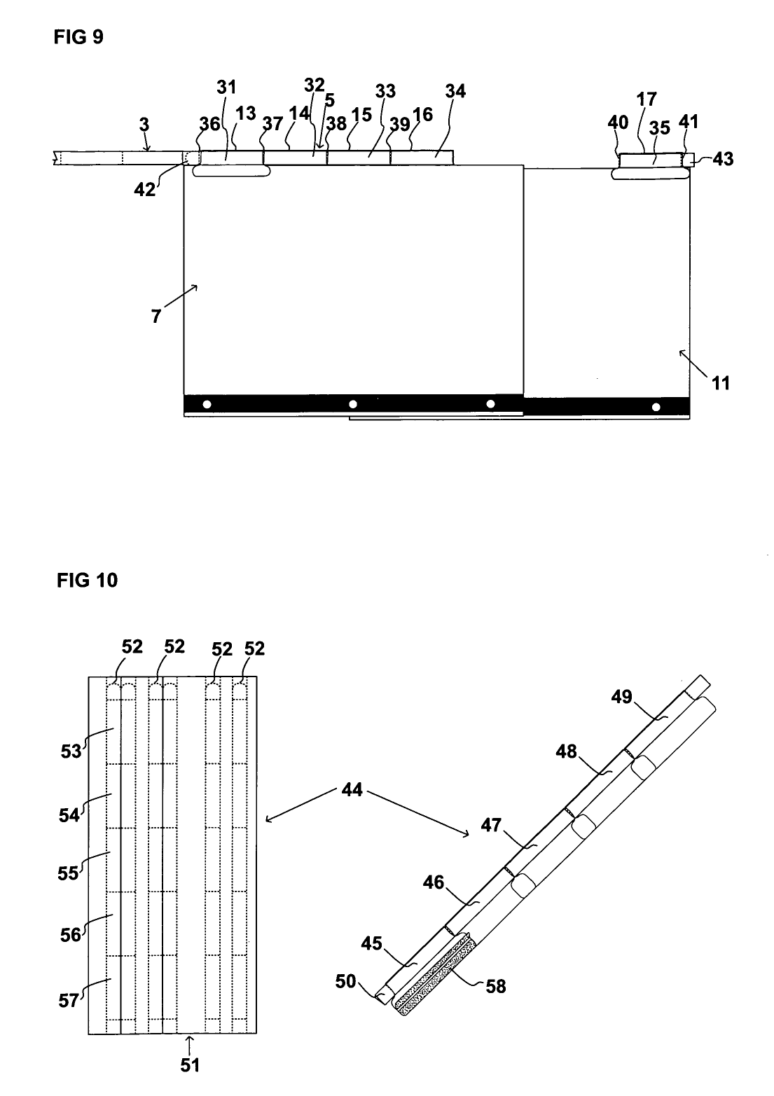

Next, the index insert 35 is first separated by tearing along the micro perforation line or die cut line 40 as best seen in FIG. 9. The alignment of index inserts is adjusted by pulling the section 42 of the insert strip 5. Subsequently, index insert 34, followed by 33, 32, 31 is separated by tearing along micro perforation lines 37-39 leaving the index inserts 31-35 in their respective insertable tabs 13-17′ pockets. The small sections 42 and section 43 are disposed by tearing along micro perforation lines 36 and 41. While the present method disclosed encourages the users to start separating the index insert from index insert 35, the users may choose to start separating from any index insert as they deemed convenient.

Although in the preferred embodiment of the present invention figured the divider sheets 7-11 as one of the major components of the insertable index application kit 1 (Refer to FIGS. 1 and 2), another alternative of an insertable index application kit may consists of five individual self adhesive insertable tabs 45-49 instead of the divider sheets 7-11. Hence, the insertable index application kit 44 consists of five individual self adhesive 58 insertable tabs 45-49, a pre-inserted strip 50, and an index insert sheet 51 having a set of index insert strips 52 in which the index insert strips 52 include a set of index inserts 53-57 as shown in FIG. 10. The self adhesive insertable tabs 45-49 with index inserts carrying index indices can be attached to the outer edge of a set of document at different locations for organizing and subdividing documents into subsection so that the categories of document can be easily identified and accessed. The number of individual insertable tabs may be of any amount even though in the present embodiment, a set of five insertable tabs is figured.

The present invention is not restricted to the embodiment and explanation disclosed in the detailed description of invention. Any person skilled in the art is able of different modifications and alterations to the present invention.

I claim:

1. An insertable tab index application kit consists of:
At least one set of divider sheets, each having insertable index tabs attached to the outer edge of the divider sheets in a predetermined order when said divider sheets are put on top of each other;
said insertable index tab is generally made of polyester film or any transparent material that may be clear or tinted a color as desired;
said insertable index tab is generally open at top and bottom end so that an index insert carrying the index indicia can be inserted into the tab;
said insertable index tabs do not overlap each other when said divider sheets are put on top of each other;
at least one index insert sheet which includes a plurality of spaced apart index insert strips;
each of said index insert strips includes a plurality of perforated index inserts in the size of the insertable tabs' pocket or smaller aligned in an arrangement that corresponds to the predetermined order of insertable index tabs when said divider sheets are put on top of each other;
at least one pre-inserted strip pre-inserted into each insertable index tab in a given set of divider sheets;
said pre-inserted strip interconnects and binds each individual divider sheet together in a set;
whereby a user may (1) separate an index insert strip from the index insert sheet, (2) attach the index insert strip to one end of the pre-inserted strip, (3) pull the pre-inserted strip away from divider sheets such that the new index insert strip with perforated index inserts for each individual tab is fitted and aligned in the insertable tabs' pockets and (4) tear along the perforated lines such that the index inserts remain in each individual insertable tab pocket.

2. An index insert sheet according to claim 1 includes a plurality of spaced apart perforated lines for helping to facilitate the separation of the index insert sheet into at least one or a plurality of index insert strips;
each individual one of said plurality of spaced apart index insert strips is divided into a plurality of index inserts defined by perforated lines, wherein each index insert is aligned in an arrangement that corresponds to the predetermined order of insertable index tabs when said divider sheets are put on top of each other;
each individual one of said plurality of spaced apart index insert strips is divided into a plurality of index inserts defined by perforated lines, said perforated lines being sufficiently strong not to tear when the insert strip is pulled through the pockets of the insertable tabs of the divider sheets.

3. An index insert sheet according to claim 2, wherein the index insert strips generally having round edges defined by perforated lines for preventing jams when pulling through the pockets of insertable tabs of the divider sheets.

4. An index insert sheet according to claim 2, wherein the index insert strips having perforated line for facilitating the folding of the insert strip over on itself forming a double layer strip.

5. An index insert sheet according to claim 2, wherein the index insert strip is a single layer strip.

6. An index insert sheet according to claim 2, wherein the index insert strips having a length of at least the sum of the lengths of all the insertable tabs' pockets in a given set of divider.

7. An index insert sheet according to claim 2, wherein the number of index inserts on each individual insert strip is generally equivalent to the number of divider sheets in a given set of divider.

8. An index insert sheet according to claim 2, is made out of relatively stiff paper or cardboard.

9. An index insert sheet according to claim 2, is made out of plastic film.

10. A pre-inserted strip according to claim 1, wherein the pre-inserted strip is pre-inserted into every insertable tab in a given set of divider; binding and holding the divider sheets together in a set.

11. A pre-inserted strip according to claim 1, wherein the pre-inserted strip having a length of at least the sum of the lengths of all the insertable tabs' pockets in a given set of divider.

12. The pre-inserted strip according to claim 10 comprises adhesive material with release coating of material at one end for facilitating the attachment of index insert strip to the pre-inserted strip.

13. The index insert sheet according to claim 10, wherein the index insert strip comprises adhesive material with release coating of material at one end for facilitating the attachment of index insert strip to the pre-inserted strip.

14. An insertable tab index application kit consists of:
at least one set of individual self adhesive insertable tabs;
said self adhesive insertable index tab is generally made of polyester film or any transparent material that may be clear or tinted a color as desired;
said self adhesive insertable index tab is generally open at top and bottom end so that an index insert carrying the index indicia can be inserted into the tab;
at least one index insert sheet which includes a plurality of spaced apart index insert strips;
each of said index insert strips includes a plurality of perforated index inserts in the size of the insertable tabs' pocket or smaller;
at least one pre-inserted strip pre-inserted into each individual insertable index tab in the set of insertable tabs;
said pre-inserted strip interconnects and binds each individual insertable index tab together in a lined up series;
whereby a user may (1) separate an index insert strip from the index insert sheet, (2) attach the index insert strip to one end of the pre-inserted strip, (3) pull the pre-inserted insert strip away from the insertable index tabs such that the new index insert strip with perforated index inserts for each individual tab is fitted and aligned in the insertable tabs' pockets and (4) tear along the perforated lines such that the index inserts remain in each individual insertable tab pocket.

15. A method of using the insertable index application kit includes:
removing the index insert strip from the index insert sheet by tearing along the perforation lines;
each of said index insert strips includes a plurality of perforated index inserts in the size of the insertable tabs' pocket or smaller;
folding the index insert strip on itself forming a double layer index insert strip if a double layer index strip is used;
peeling off the release coating material adhered to either one end of the pre-inserted strip or the index insert strip exposing the adhesive coating material;
attaching the index insert strip to the pre-inserted strip;
pulling the pre-inserted strip out and away from the insertable tabs such that the index insert strip replaces the pre-inserted strip and fitted in the insertable tabs;
aligning the index inserts on the index insert strip with their matching insertable tabs' pockets;
tearing along the perforated lines to separate the index inserts from the index insert strip leaving each individual index insert in its respective insertable tab's pocket.
